(19) United States
(12) Patent Application Publication
(10) Pub. No.: US 2006/0255564 A1
(43) Pub. Date: Nov. 16, 2006

(54) Steerable wheeled cart

(75) Inventor: William H. Ayre, Seattle, WA (US)

Correspondence Address: SPECKMAN LAW GROUP PLLC, 1201 THIRD AVENUE, SUITE 330, SEATTLE, WA, 98101, US

(73) Assignee: Bayre Design, Seattle, WA (US)

(21) Appl. No.: 11/128,700

(22) Filed: May 12, 2005

(51) Int. Cl. B62B 7/06

(52) U.S. Cl. 280/642

(57) ABSTRACT

Provided herein is a wheeled cart useful for the transport of children and/or other cargo. The wheeled cart comprises a steerable member that permits user-controlled movement of the front wheel and hence steering while retaining contact of all three wheels with the walking or running surface. Inventive wheeled carts are suitable for use by the user while walking or running and simultaneous transport of a child and/or other cargo, provide a roll-cage for protection of the child and/or cargo in the event or a roll-over accident, and are advantageously adapted for folding and ease of transport when not in use.

### BACKGROUND OF THE INVENTION

1. Technical Field of the Invention

The present invention relates generally to wheeled carts useful for the transport of children and/or other cargo. More specifically, provided herein are wheeled carts having a steerable member that permits user-controlled movement of the front wheel and hence steering while retaining contact of all three wheels with the walking or running surface. Wheeled carts disclosed herein are suitable for use by the user while walking or running and simultaneously transporting a child and/or other cargo, provide a roll-cage for protection of the child and/or cargo in the event or a roll-over accident, and are advantageously adapted for folding and ease of transport when not in use.

2. Description of the Related Art

Various designs of wheeled carts known in the art can be utilized by the user to transport children and/or other cargo, for example, while the user is jogging or running. These wheeled carts are typically configured with three wheels, a frame assembly, and one or two seats and/or storage compartments. Some of these wheeled carts are configured for folding, disassembly, or a combination of both, thus providing for convenience and versatility in transportation and storage.

U.S. Pat. No. 6,533,310 describes a collapsible three-wheeled stroller for transporting a child that includes a frame movable between folded and unfolded conditions, a handle mounted on an upper portion of the frame for pushing the stroller, one front wheel and two rear wheels rotatably mounted on a lower portion of the frame, and a seat on the frame for supporting a child. The frame is constructed from a plurality of articulated frame members movable from the unfolded condition to the folded condition with accompanying motion of the rear wheels toward one another and a generally forward and downward motion of the handle.

U.S. Pat. No. 6,196,572 describes a convertible trailer and stroller having a pair of frame blocks mounted to a frame member, each proximate the two rear wheels of the jogging stroller. The frame blocks are each attached to a wheel block at a wheel pivot that interconnects the frame blocks to their respective wheel blocks. A pair of wheels having hub axle ends is received into a wheel bearing within each of the wheel blocks, and the wheel blocks are rotatable about the respective block pivots to selectably raise or lower each wheel relative to the block pivots. In the lowered wheel or stroller configuration, a high ground clearance for all terrain operation is provided, while in the raised wheel or trailer configuration, a low and stable center of gravity is provided. The convertible trailer and stroller can also include an upper bar that attaches to the wheel blocks. The upper bar converts from a handle bar position to a roll bar position as functions of the pivotable rotations of the wheel blocks about the frame blocks. The handle bar position provides a push or pull point in the stroller configuration, while the roll bar position operates in the trailer configuration to provide protection to a passenger in a tip over.

U.S. Pat. No. 6,722,689 describes a jogging stroller for carrying a baby that includes three wheels mounted on a frame that holds a cloth seat and includes frame rails that project upwardly and rearwardly from a single front wheel to a horizontal handlebar member at the rear of the stroller. A pair of handles are attached to the handlebar members by a clamp and these include a stem member that extends outwardly from the stroller handlebar and are connected to a perpendicular handle element that can rotate about the stem member and the stem members can be rotated about the axis of the horizontal stroller handlebar and can be slid along the handlebar. The handle elements can be fixed in space in a position desired by the user or can be left loose enough to rotate during use. The handle elements have a coil spring inside a grip member, allowing the handles to flex as the user jogs, thereby permitting more natural motion of the hands and shoulders during jogging.

U.S. Pat. No. 6,779,804 describes a jogging stroller in which a control block is coupled to the front fork and pivoted with the front fork to the front side of the front frame tube of the stroller frame. An operation rod is provided in the control block and selectively shifted between a first position wherein the control block and the front fork are unlocked for a swivel motion relative to the front frame tube of the stroller frame, and a second position wherein the control block and the front fork are locked and prohibited from swiveling relative to the front frame tube of the stroller frame.

U.S. Pat. No. 6,830,260 describes a foldable three-wheeled jogging stroller having a lower frame assembly including an axle for supporting two rear wheels, the axle having a pivotally coupled fork assembly to support a front wheel and a pair of fixedly attached upright support tubular members. An upper frame assembly includes a U-shaped handlebar having first and second extension tubular members each fixedly attached to an interconnect member, each interconnect member configured for hinged attachment of an upright support member and for slidably receiving a first end of one of third and fourth tubular members whereby the interconnect member can slide freely along its respective tube to enable an erect upper frame assembly to fold into a collapsed position overlaying the base assembly. The other ends of the third and fourth tubular members are attached to a footrest that further has extension tubular members coupled to the front wheel support.

U.S. Pat. No. 6,863,297 describes a fold flat walking or jogging stroller, which includes at least three wheels, all having pivoting wheel support units. The wheel support units include, in various embodiments, simple manually manipulable methods to latch each wheel in the operative or stowed flat positions, which effectively allows the device to fold to a flat profile without any wheel being detached. Associated features include a pivoting or floating transverse axle replicating unit, which pivots and latches to replicate a typical fixed wheel axle, but pivots to a fold flat stowed position. The features may also be applied to other types of wheeled carrier devices such as gurneys, golf bag carriers, and hunting game carners.

U.S. Pat. No. 4,432,561 describes an amusement tricycle wherein the operator is transported in an inclined position on a hammock cradle. The cradle is carried by a front wheel that does not pivot relative to the cradle. Instead, the cradle and wheel rotate about a downwardly sloping axis to turn. The cradle is supported to the rear by a two wheel buggy. The cradle is mounted on the buggy by a pivot. The pivot rotates about its axis. The buggy in turn, is stabilized by pivotable attachment to the cradle.

U.S. Pat. No. 4,572,535 describes a three-wheeled vehicle having a front body member carrying the front wheel and seat, pivotally connected to a rear body member carrying the rear wheels and handlebar. The pivotable connection is designed to pivot the front body member around a pivotal axis that is projected upwardly and rearwardly at a location rearward of the front wheel whereby pivoting produces sideward and rearward tilting of the front wheel and opposite turning of the rear wheels. Steering is achieved by such pivoting of the front body member that, in turn, is achieved by a sideward swinging of the seat that is positioned between the two pivotable connections. The rear wheels are canted to provide increased stability for the vehicle as it is maneuvered through a turn.

U.S. Pat. No. 5,354,084 describes a three-wheeled vehicle having a front body member carrying a front wheel seat, hand pedals and leg supports pivotally connected to a rear body member carrying the rear wheels and handlebar. The front body member includes a seat for the operator and pedals to be operated by the rider's hands. The seat, pedals, front wheel and leg supports are maintained in a fixed relationship whereby pivoting of the front frame portion simultaneously pivots the seat, pedals, drive line, and front wheel to maintain a fixed relationship while turning and supplying power to the front wheel. A stabilizing dampener between front and rear frame sections provides smooth steering and inhibits undesired, inadvertent, side to side movement of the rider's body and thereby repetitive back and forth turning of the vehicle.

U.S. Pat. No. 4,789,173 describes a three-wheel vehicle having front and rear frame sections supporting a single front wheel and a pair of rear wheels, respectively. The frame sections are pivotally interconnected about an inclined axis defined by a front lower and rear upper pivotable connection. The upper pivotable connection is provided on a swivel bar which is pivotally connected to the rear frame section for swivel pivoting of the pivotable connection defining the inclined axis. A seat on the front frame section positioned substantially above the swiveled pivotable connection is shifted from side-to-side with the pivoting of the swivel bar and inclined axis. A handle from the swivel bar enables a rider to control the swivel bar for shifting of the rider's weight and increased or decreased articulation of the vehicle frame and thus turning of the vehicle to thereby increase or decrease the turning that is induced by pivoting of the front frame section about the inclined axis.

The strollers and three-wheel vehicles described above remain limited in the area of steering, frame assembly design, and optimum folding characteristics.

### SUMMARY OF THE INVENTION

Thus, it is an object of the present invention to provide a system to overcome the aforementioned disadvantages and problems. The present invention provides within certain embodiments, wheeled carts that allow controlled steering and turning motion of the wheeled cart while all wheels retain contact with the ground surface.

In one embodiment, the steering feature of the inventive wheeled cart is defined by the combination of an upper frame assembly that is pivotally connected to a lower frame assembly at a steering assembly in front and a guiding assembly in the rear. The upper frame assembly includes a steering post that is connected to the steering assembly of the lower frame assembly. The upper frame assembly includes a guiding arced tube that is releasably connected to a guiding assembly of the lower frame assembly by a releasable latch.

The upper frame assembly includes a front wheel assembly and a plurality of tubular members, which include a guiding arced tube, upright struts, main seat tubes, axial tubes and members, and a steering post, fixedly, releasably or insertably connected to one another. Collectively, the combination of tubular members creates a cage in which a rider and/or cargo is protected from contact with the ground in the event of a roll-over accident.

The lower frame assembly includes at least two rear wheels and tire assemblies and a plurality of tubular members attached forwardly at a steering assembly. The lower frame assembly is further provided with a guiding assembly that is pivotally connected to a pair of the rear tubular members of the lower frame assembly. The guiding assembly is provided with a guiding channel, which receives and releasably engages a guiding arced tube of the upper frame assembly by way of a releasable latch. The guiding arced tube, when engaged, is slidably movable within the guiding channel.

The steering action of the wheeled cart is controlled by the pivoting movement of the upper frame assembly about the inclined pivotal axis of the steering post through the steering assembly. This pivotal axis of steering typically approximates 45° inclined axis relative to the ground surface. Pivoting of the upper frame assembly in relation to the lower frame assembly causes a relative turning and tilting action of the upper frame assembly including the front wheel assembly. This tilting and turning of the front wheel assembly produces a steering movement of the embodiment of the inventive cart when in motion. Pivoting of the upper frame assembly in relation to the lower frame assembly is controlled and restricted, in part, by movement of the guiding arced tube within the guiding channel of the guiding assembly.

The steering movement of the presently described wheeled cart is controllable by the user through clockwise or anticlockwise movement of a handle member, optionally connected adjustably to the upper frame assembly. For example, when the user twists the handle member towards the right, it causes the upper frame assembly to pivot in a clockwise motion around the axis of steering thereby tilting and turning the front wheel assembly toward the right while simultaneously causing the guiding arced tube to slide towards the left within the guiding channel.

Within certain embodiments, the inventive wheeled cart is capable of being re-positioned from a fully-open configuration for use to a fully-folded configuration for storage and transport. The folding action is initiated by pushing down on the upper side of the releasable latch of the guiding assembly thereby releasing the arced tubular member from an opening in the guiding channel. The inventive wheeled cart will begin to fold as the user lifts and directs the upper frame assembly towards front wheel and tire assembly. With the releasable latch in such an open position, the upper rear axial tube, of the upper frame assembly, is lifted, thereby causing the guiding arced tubular member to be lifted up and away from the guiding assembly. Further lifting of the upper rear axial tube causes the rear wheel assemblies to rotate forward and down followed by the attached guiding assembly. A gentle forward pressure on the guiding assembly pushes the wheels further forward into alignment alongside the front wheel. With continued forward lifting, and lowering, the upper frame assembly is moved forward and downward toward the front wheel and tire assembly until the upper frame assembly comes to a stop at a front portion of the front wheel and tire assembly. In a fully-folded configuration, the front and rear wheel and tire assemblies are in parallel juxtaposition, which, collectively, are positioned within the folded frame assembly. The handle member may be released, thereby permitting folding onto the folded frame assembly to achieve a fully-folded configuration suitable for storage and transport.

These and other aspects of the present invention will become apparent upon reference to the following detailed description and attached drawings. All references disclosed herein are hereby incorporated by reference in their entirety as if each was incorporated individually.

### BRIEF DESCRIPTION OF THE FIGURES

The present invention will be described in greater detail in the following detailed description, with reference to the accompanying drawings, wherein:

FIG. 1A shows a side view of a steerable wheeled cart and FIG. 1B shows an exploded side view of the steerable wheeled cart of FIG. 1A;

FIG. 2A shows a front view of the steerable wheeled cart of FIG. 1A and FIG. 2B shows an exploded front view of the steerable wheeled cart of FIG. 2A;

FIG. 3 shows a rear view of the steerable wheeled cart of FIG. 1A;

FIG. 4A shows the steerable wheeled cart in an un-turned, straight-ahead configuration; FIG. 4B shows the steerable wheeled cart in a right-turned configuration;

FIG. 5 shows a perspective view of an exemplary steering assembly of a steerable wheeled cart of the present invention;

FIG. 6A shows a perspective view of an exemplary guiding assembly of a steerable wheeled cart of the present invention;

FIG. 6B shows another perspective view of an exemplary guiding assembly of a steerable wheeled cart of the present invention;

FIG. 7A shows a cross-sectional side view of the exemplary guiding assembly of FIG. 6A in a fully-engaged configuration;

FIG. 7B shows a cross-sectional side view of the exemplary guiding assembly of FIG. 6A in a fully-released configuration;

FIG. 8 shows a side view of the steerable wheeled cart of FIG. 1A in a fully-collapsed operational position; and

FIG. 9 shows a perspective view of the steerable wheeled cart of FIG. 1A in a fully-opened operational position.

### DETAILED DESCRIPTION OF THE INVENTION

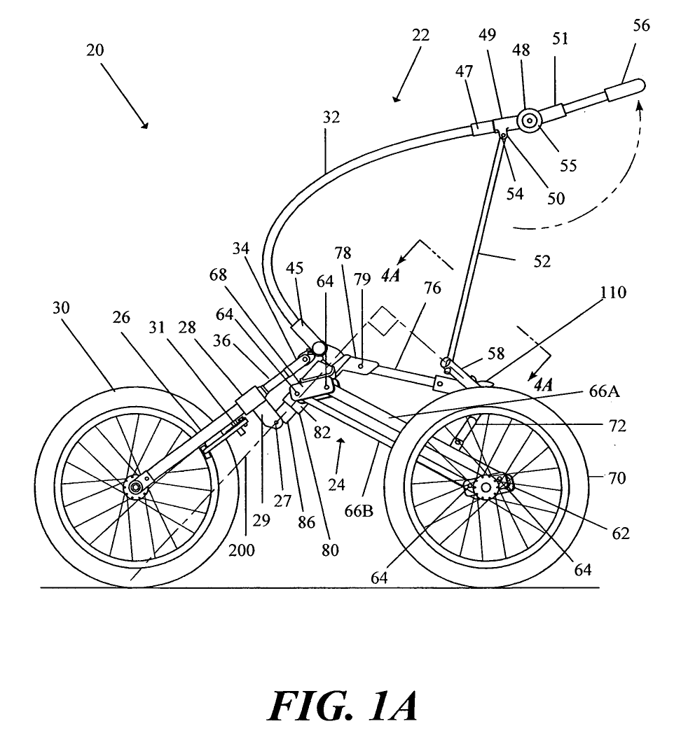

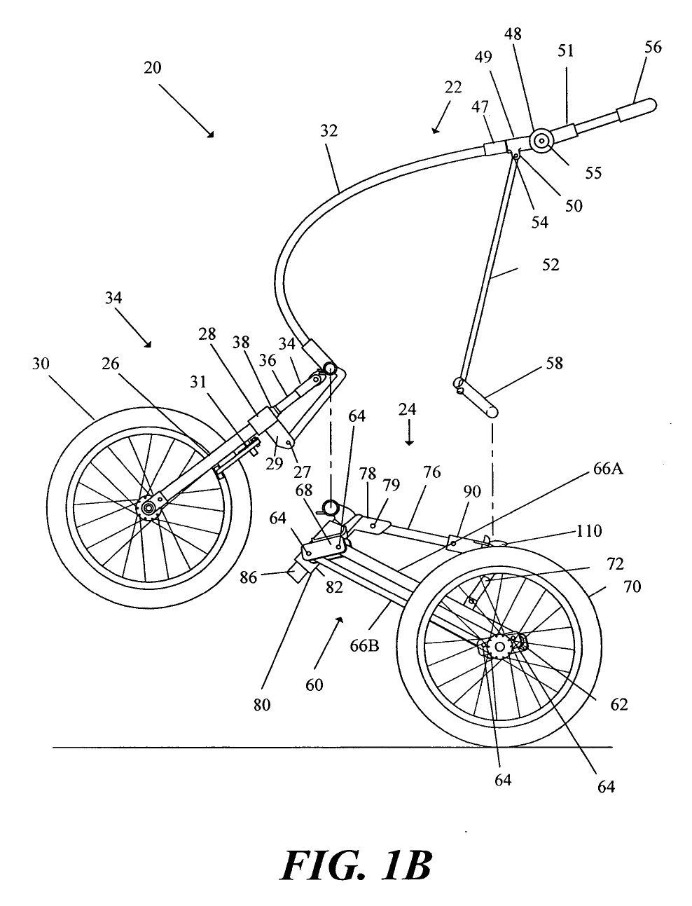

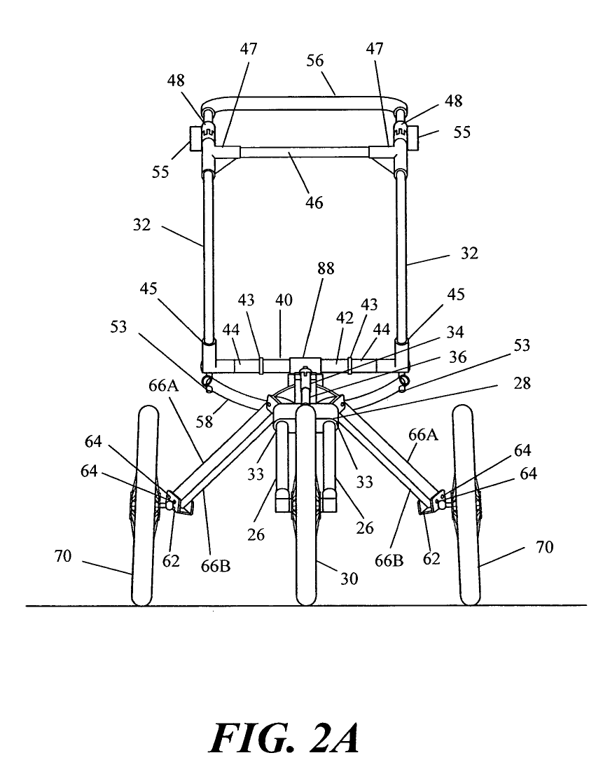

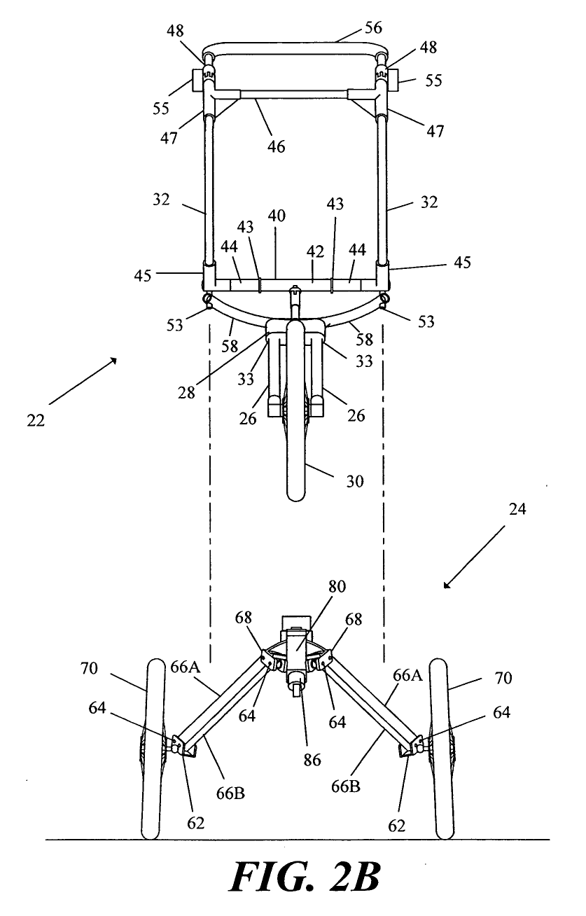

Referring to FIGS. 1A, 1B and 2B, an embodiment of wheeled cart 20 comprises an upper frame assembly 22 and a lower frame assembly 24.

When introducing elements of the present invention or the preferred embodiment(s) thereof, the articles “a”, “an” “the” and “said” are intended to mean that there are one or more of the elements. The terms “comprising”, “including” and “having” are intended to be inclusive and mean that there may be additional elements other than the listed elements.

Upper frame assembly 22 comprises front fork assembly 39 which includes front wheel assembly 30. Upper aspect of fork assembly 39 is connected to lower end of steering post 86 and lower end of support post 34. Upper end of post 34 is connected to upper aspect of steering post 86. Upper aspect of steering post. 86 is connected to axial mid frame member 40. Left and right main arched seat tubes 32 are fixedly held apart at their lower ends by connection to lateral ends of mid frame member 40. Seat tubes extend upward and rearward in a generally arced manner. Upper ends of seat tubes 32 are connected to, and fixedly held apart by upper axial tube 46, and pivotally connected to handle tube 56 and upper ends of left and right upright seat struts 52. Seat struts 52 are fixedly attached at their lower ends to left and right ends of guiding arced tube 58.

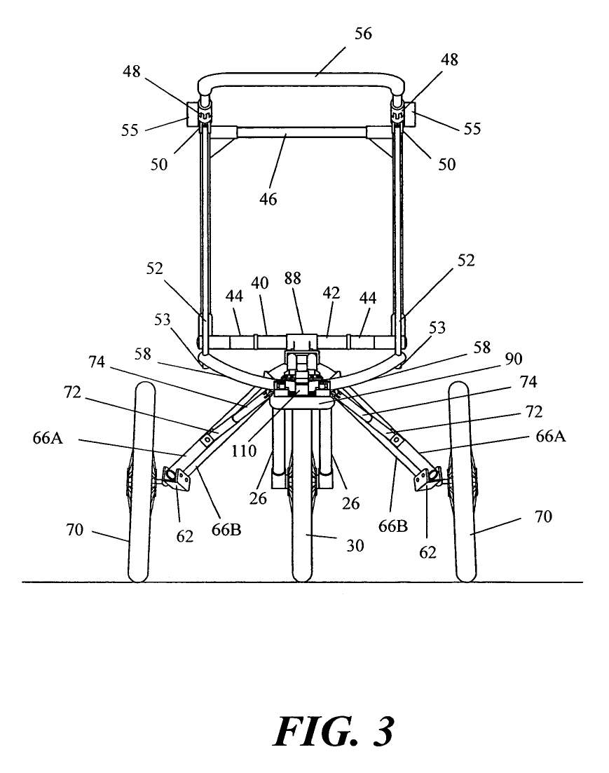

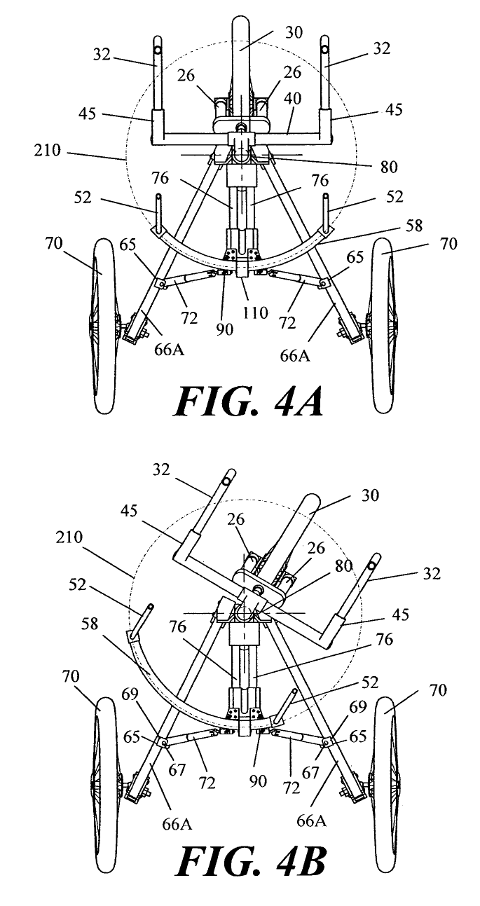

Lower frame assembly 24 comprises left and right rear arm assemblies 60 (including rear wheels 70), pivotally attached to steering assembly 80 anteriorly. In their open functional position the two rear arm assemblies 60 diverge from front to back to support the rear wheels 70 laterally spaced (see FIG. 4A). Rearward aspect of arm assemblies 60 are pivotally attached to lower ends of left and right rear support struts 72. Upper ends of struts 72 converge medially and are pivotally attached to guiding assembly 90 at its rearward aspect (see FIGS. 3 and 4A). Forward aspect of assembly 90 is fixedly attached to the rearward ends of left and right parallel support arms 76. Forward ends of support arms 76 are pivotally attached to steering assembly 80 at interconnect bracket 78. Support arms 76 are allowed to pivot downward and forward from approximate horizontal rearward position when open to approximate parallel position with pivotal axis 200 of steering assembly 80.

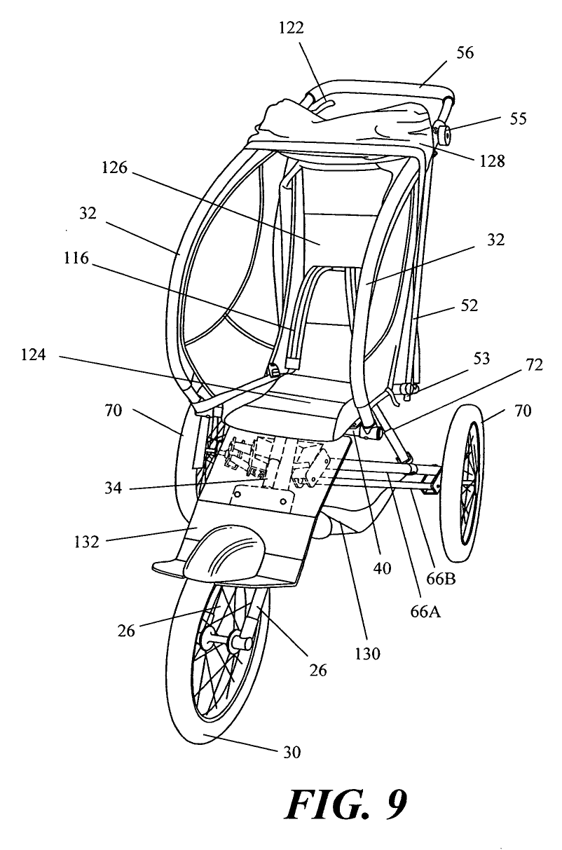

Upper frame assembly 22 is pivotally connected to lower frame assembly 24 anteriorly by steering post 86 within steering assembly 80. Additionally, when fully open in its functional condition, upper frame assembly 22 is releasably pivotally connected to lower frame assembly 24 posteriorly by arced tube 58 in guiding assembly 90. Thus, wheeled cart 20 comprises upper frame assembly 22, which supports a flexible child seat 124 (see FIG. 9), and a child (not shown), pivotally above lower frame assembly 24.

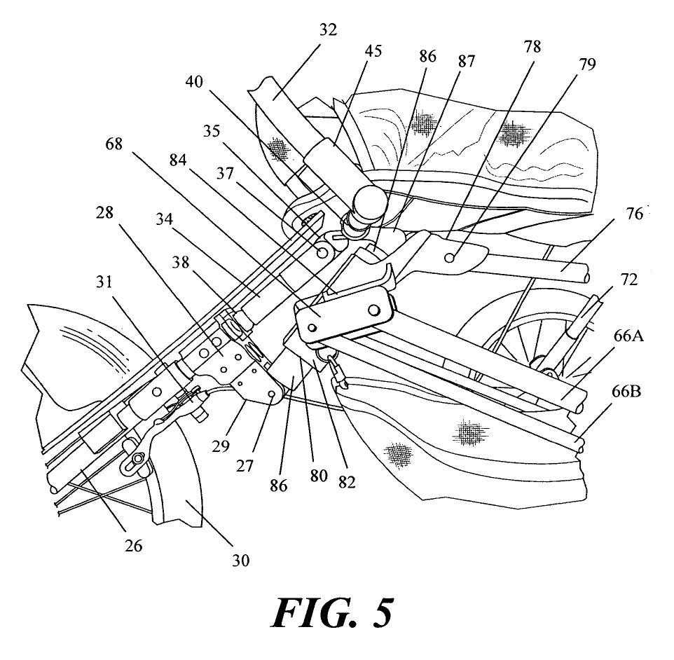

Referring to FIGS. 1A, 1B, and 5, upper frame assembly 22 comprises front wheel and tire assembly 30 releasably rotatably attached (by conventional methods) to first ends of left and right front fork members 26. Front wheel assembly 30 of this embodiment is a conventional spoked wheel typically measuring between about 9 and about 24 inches in diameter and optionally having a pneumatic tire mounted thereon. It is contemplated that other types of tires may be used, such as molded urethane foam, or solid tires. Front fork members 26 are held in fixed parallel juxtaposition by insertion, at their respective second ends, into left and right apertures 33 of front fork connector 28 and are fixedly attached to connector 28. A conventional caliper brake assembly 31 is optionally located between and below front forks anteriorly to connector 28. Bracket 29 is mechanically fixedly attached to the lower surface of fork connector 28. Front fork assembly 39 comprises front wheel assembly 30, front forks 26, brake assembly 31, fork connector 28, and its attached bracket 29. Front fork assembly 39 is axially pivotally connected to the lower end of steering post 86 by pivot pin 27 through bracket 29 and bushings (not shown) abutting lower end of steering post 86 within the bracket 29. Unless otherwise noted in the continuing descriptions below, pivot pins (such as 27 above) may be rivets, shoulder bolts or other suitable fasteners.

Referring to FIGS. 2A and 5, upper end of steering post 86 comprises a gooseneck 87 (typical of bicycle handlebar stems) with axial tubular member 88 protruding proximally. Vertical flange 35 fixedly extends downward and proximally from tubular member 88. Upper end of tubular post member 34 is pivotally attached to flange 35 by axially mounted pivot pin 37. Lower end of post 34 is flexibly attached to the upper surface of front fork connector 28 at ball and socket joint 38. Further, post 34, optionally, comprises shock absorbing member 36 such that, in combination, the distance between the upper pivot pin 37 and the lower ball joint 38 can vary as the shock absorbing member 36 compresses. Compression of the spring in shock member 36 is permitted by axial pivoting between steering post 86 and front fork assembly 39 at pivot pin 27, as well as some pivoting at connections at both ends of post 34. It is to be understood that attachments to post 34 can be other suitable connections used in conjunction with other contemplated configurations of the post. In addition, other configurations of the front fork assembly 39 are contemplated such as standard unsprung bicycle front forks.

Referring to FIG. 2A, tubular member 88 of gooseneck 87 of upper steering post 86 is connected to axial mid frame member 40. Mid frame member 40 comprises outer tubular member 42 and inner tubular member 44. Outer tubular member 42 passes through, and is mechanically fixedly attached at its center, to tubular member 88. Inner tubular member 44 passes through outer tubular member 42 with clearance between outer and inner diameters, respectively, permitting outer tubular member 42 to act as a supportive bushing or cylindrical sleeve. Pivotal rotation of inner tubular member 44 is allowed around the axis of mid frame member 40. Inner tubular member 44 is mechanically restricted from lateral motion within outer tubular member 42 by left and right stops 43 fixedly attached to inner tubular member 44. Left and right ends of inner tubular member 44 are fixedly attached to left and right L-shaped tubular connectors 45. Connectors 45 are variations on common tube connectors. Connectors 45 may be made of plastic or other suitable material readily available to those skilled in the art. Connectors 45 are mechanically releasably attached to left and right main seat tubes 32 by conventional spring pins (not shown) located inside the ends of seat tubes 32. Releasable attachment facilitates frame assembly and removal of fabric seat 124 (see FIG. 9) for cleaning. It is to be noted that other connectors can be used or direct attachment, such as by welding, within the scope of the invention.

Attachment of the main seat tubes 32 (and their associated upper frame structures to be described below) to the pivotal inner tubular member 44 thus allows folding of the upper frame assembly 22 about the axis of mid frame member 40 within inner tubular member 44. This folding portion may be otherwise constructed within the scope of this invention.

Referring to FIGS. 1B and 2B, main seat tubes 32 are generally arched upward and backward (also perspective FIG. 9). Upper rearward ends of seat tubes 32 pass through, and are fixedly attached to, upper left and right L-shaped tubular connectors 47. Left and right ends of upper axial frame tube 46 are inserted into connectors 47 and releasably attached by conventional spring pins (not shown) located inside left and right ends of axial tube 46. Connectors other than discussed may be used within the scope of the invention. Upper axial frame tube 46 is parallel to axial mid frame tube 40. Upper tube 46 and mid frame tube 40 maintain right and left main seat tubes 32 in juxtaposition.

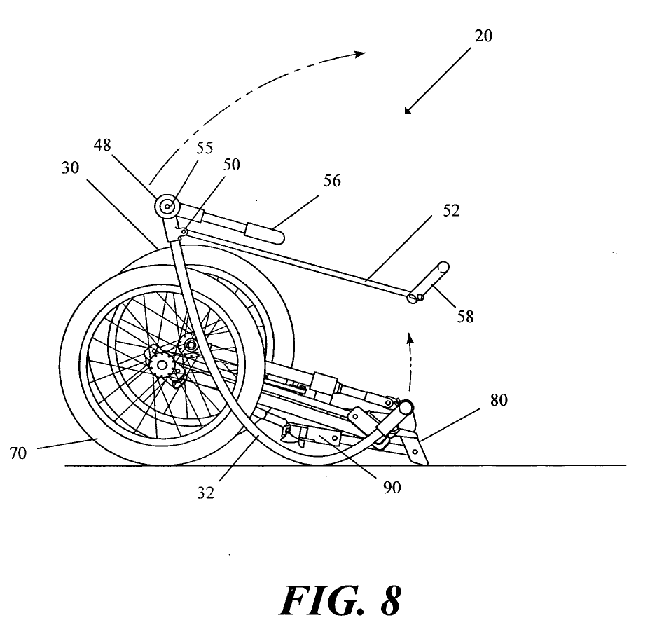

Rearward of connectors 47, the ends of main seat tubes 32 insert into, and are fixedly attached to, left and right handle adjustment assemblies 48. Adjustment assemblies 48 comprise seat tube connectors 49, upright strut connectors 50, adjustable rotatable knobs 55, and handle tube connectors 51. Left and right ends of handle 56 are inserted into, and fixedly attached to, corresponding handle tube connectors 51 of handle adjustment assembly 48. Handle tube connecters 51 and seat tube connectors 49 of adjustment assembly 48 are rotatably adjustably attached at the axis of adjustable rotatable knobs 55. Axially co-facing surfaces of connectors 49 and 51 are equipped with interlocking radial teeth (not shown) that are released or engaged by adjustable knobs 55. Release or engagement of the teeth (not shown) allows handle bar 56 to be folded for compact storage and transport, or adjusted in height to individual comfort for use (see FIGS. 1A and 8). This radial teeth rotational adjustment is commonly known in the industry. It is noted that other types of handle adjustment are contemplated within the scope of the invention.

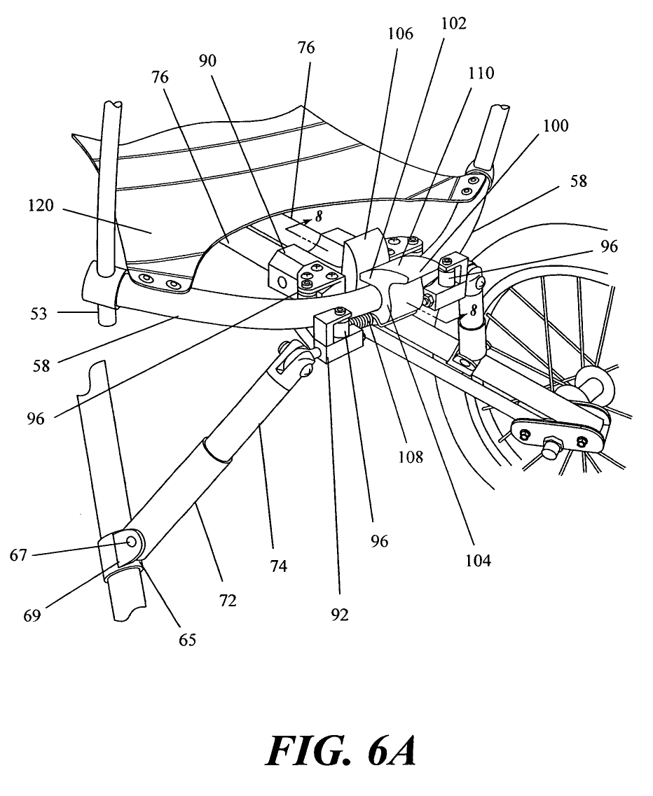

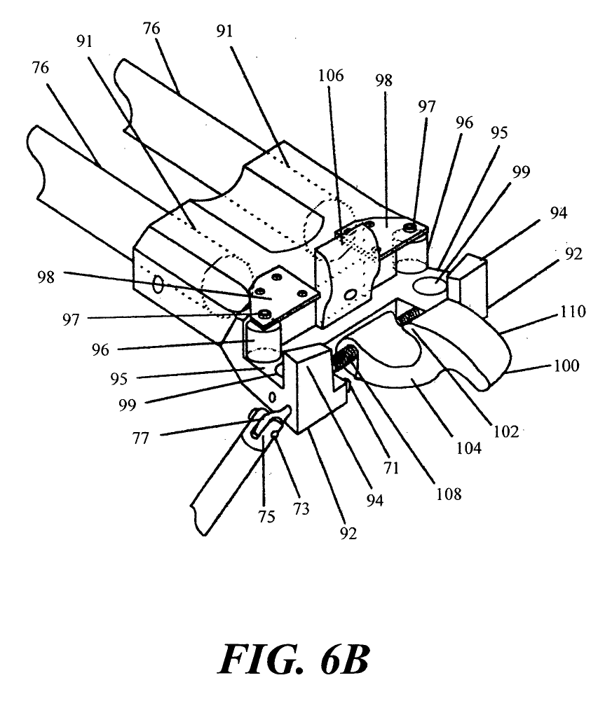

Referring to FIG. 1B, left and right upright rear seat struts 52 axially pivotally attach at their upper ends to strut connectors 50 by pivot pins 54. Lower ends of seat struts 52 pass through and are fixedly attached to left and right ends of guiding arced tube 58. Orientation of arced tube 58 in the open, in use position, is such that it approximates an arc, of an imaginary circle 210, perpendicularly centered on steering axis 200 (see FIGS. 1A, 4A, and 4B). Upper connections of seat struts 52 at pins 54 allow arced tube 58 and struts 52 to rotate toward main seat tubes 32, facilitating compact folding in this favored embodiment. Rearward motion of seat struts 52 and arced tube 58 is constrained by underseat folding plastic membrane 120 (see FIG. 6A). Membrane 120 is attached by rivets (four shown), or other suitable fasteners, to arced tube 58 and in front at inner tubular member 44 of axial mid frame assembly 40 (attachment not shown). Membrane 120 cushions rider from elements of steering assembly 80 and provides a low friction surface for motion of seat 124 over these elements during rotational motion of steering of cart embodiment 20. It is to be appreciated that the joined frame elements may be attached by connections other than discussed. It is further contemplated that conjoined elements can otherwise consist of a single bent contiguous section of tubing or other structure within the scope of the invention.

Referring to FIGS. 1B and 2B, lower frame assembly 24 comprises left and right rear wheel and tire assemblies 70 releasably rotatably mounted to left and right rear arm connectors 62 by conventional releasable axle pins (not shown) readily available to those skilled in the art. The rear wheels of this embodiment are conventional spoked wheels measuring about 9 to about 24 inches in diameter and, optionally, having a pneumatic tire mounted thereon. It is contemplated that other types of tires may be used, such as molded urethane foam, or solid tires. Rear arm connectors 62 are pivotally connected at rear ends of left and right sets of equal length parallel rear arms 66A and 66B by pivot pins 64. Forward ends of these parallel rear arms 66A and 66B are pivotally connected to left and right forward arm connectors 68 (at steering assembly 80) by pivot pins 64. Each rear arm assembly 60 comprises rear wheel assembly 70, rear connectors 62, arms 66A and 66B, forward connectors 68 and corresponding connecting pins 64. Forward arm connectors 68 in conjunction with rear arm connectors 62 maintain parallel juxtaposition of arms 66A and 66B throughout the range of motion allowed by spacing of pivots defined by pins 64. Forward arm connectors 68 are fixedly attached to left and right connecting plates 84 which are fixedly attached to outer sleeve 82 of steering assembly 80. Connecting plates 84 are oriented such that forward arm connectors 68 are angled downward and inward in relation to steering assembly 80. This orientation is such that, rear arm assemblies 60 rotate downward, forward, and inward, during folding. Rear wheels 70 are maintained in a parallel orientation on their respective left and right sides as they approach medially. Suitable wheel folding technologies are readily available to those skilled in the art. It is contemplated that two or more attached elements described above may be made as one, or alternative rear arm assemblies may be used within the scope of the invention, such as, for example, having a single arm element per side, or assemblies with fixed rear wheel width.

Referring to FIGS. 3, 4A, and 4B, lower frame assembly 24 further comprises left and right rear support struts 72 that are connected at 65 to rearward aspects of left and right arms 66A. Connection 65 comprises a U-shaped clevis 69 rotatably mounted on arm 66A by a rivet (not shown) or other suitable fastener. Lower end of support strut 72 is pivotally mounted inside the clevis 69 by pivot pin 67. Connection 65 thus allows supports 72 to rotate and pivot in relation to struts 66A during folding or movement of rear arm assemblies 60.

Referring to FIGS. 6A and 6B, upper ends of support struts 72 converge medially to connect pivotally to flanges 77 by pivot pins 73 at left and right rear elements 92 of guiding assembly 90. Flange 77 is rotatably connected to rear element 92 by shaft (not visible) to end fastener 71. Rotatable flanges 77 thereby form a multi-axis connection 75 with struts 72. Multi-axis connections 75 permit supports 72 to pivot forward and medially during folding and rearward and laterally during unfolding of the rear arm assemblies 60. Support struts 72 further comprise shock absorbing members 74, exemplified by a coil spring. Shock members 74 allow limited independent left and right vertical motion of the rear arm assemblies 60. Thus, by this embodiment, rear arm assemblies 60 provide cushioning for both the rider and user during travel of the cart over uneven surfaces. It is to be understood that other configurations of struts 72 and their connections are contemplated within the scope of this invention, including coincidental attachment of the struts to an intermediate member.

Referring to FIGS. 1B, 4A, 4B, 6A, and 6B, lower frame assembly 24 further comprises a guiding assembly 90 that is pivotally connected to steering assembly 80 by parallel support arms 76. Rearward ends of arms 76 are inserted into left and right parallel apertures 91 in guiding assembly 90, and fixedly attached to this assembly. Forward ends of arms 76 are axially pivotally attached to interconnect bracket 78 which is fixedly attached to the upper posterior aspect of outer sleeve 82 of steering assembly 80. Support arms 76 and guiding assembly 90 are allowed to rotate around axis of pin 79 downward and forwardly during folding, and rearward and upwardly during unfolding of the rear arm assemblies 60. Upward travel of parallel support arms 76 is limited to approximately horizontal by interconnect bracket 78. Other configurations of arms and connections are contemplated without departing from the scope of the invention.

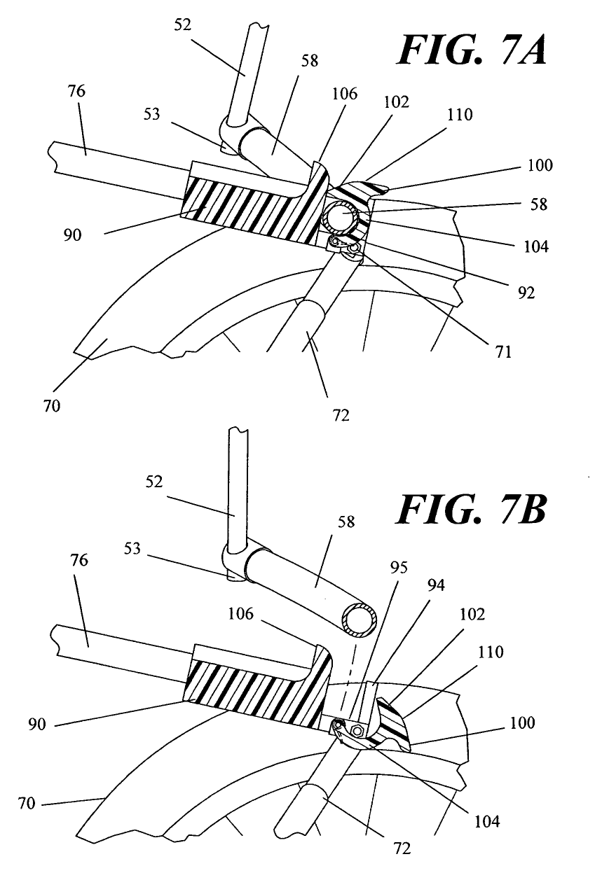

Referring to FIGS. 6A, 6B, 7A, and 7B, guiding assembly 90 comprises rear elements 92 with upward protrusions 94 with or without rollers 96 as seen in FIGS. 6A and 6B. Centered between these rear elements 92 is latch 110 rotatably mounted on axial shaft (not visible) affixed between left and right rear elements 92. Hidden shaft is surrounded by rotationally tortioned spring 108 which holds latch 110 in its forward most rotated position against latch post 106. Latch 110 comprises curved neck 104, forward projecting beak 102 and rearward projecting release tab 100.

Referring to FIG. 6B and 7A, lateral upward protrusions 94 and latch neck 104 comprise the rear elements of a guiding channel 95 into which arced tube 58 of upper frame assembly 22 is releasably attached in the open configuration of cart embodiment 20. Forward elements of guiding channel 95 comprise centrally located latch post 106 and laterally situated low friction rollers 96. Rollers 96 are rotatably attached in approximately axial relationship to pivotal axis 200 of steering assembly 80 by pivot pins 97 through retaining flange 98. Flanges 98 are affixed to body of guiding assembly 90 by screws (three are shown) or other suitable fasteners. The lower bounds of guiding channel 95 comprise low friction bushings 99 located laterally between the forward rollers 96 and the upward protrusions 94 to the rear. Upper bound of the guiding channel 95 is the undersurface of latch beak 102. It is to be understood that positioning and orientation of guiding channel elements may be other than described without departing from the scope of the invention Referring to FIG. 5, lower frame assembly further comprises steering assembly 80, which is made up of outer sleeve 82, affixed left and right connecting plates 84 (which attach left and right forward strut connectors 68), and affixed interconnect bracket 78 in the upper rear aspect (which pivotally attaches parallel support arms 76 to which guiding assembly 90 is attached). Steering assembly 80 thus connects all forward projecting elements of the lower frame assembly 24 and holds them in relation to each other relative to the upper frame assembly 22 which pivots within the steering assembly on its steering post 86. The steering assembly may be otherwise constructed within the scope of this invention.

Referring to FIGS. 1A, 1B, and 5, the upper frame assembly 22 is fixedly pivotally connected to lower frame assembly 24 anteriorly at its steering post 86 within lower frame steering assembly 80. Steering post 86 pivots within standard rotary elements (not shown) inside outer sleeve 82 of steering assembly 80. It is contemplated that upper and lower frame assemblies may be pivotally attached by ways other than shown such as by a flexible member connecting along, and bending at, the steering axis without departing from the scope of the invention.

Referring to FIGS. 6A, 7A, and 7B, upper frame assembly 22 is releasably attached to lower frame assembly 24 posteriorly by arced tube 58 in guiding channel 95. Arced tube 58 is constrained within guiding channel 95 in its rearward motion by the upward projections 94 lateral to latch 110 and cannot push latch 110 open rearwardly. Forward motion of arced tube 58 within guiding channel 95 is constrained by roller elements 96 laterally and latch post 106 medially. Upward motion of arched tube 58 within guiding channel 95 is constrained by the underside of curved beak 104 of latch 110 unless the latch is opened prior to such upward motion. Release of arced tube 58 from guiding channel 95 is effected by manual action (inclusive of foot) to open latch 110 against torsional rotational spring 120 and subsequent lifting of arced tube 58 from channel 95. Latch 110 is configured such that it effectively traps arced tube 58 when arced tube 58 is lifted without active opening of latch 110 by release tab 100.

Referring to FIGS. 7A, and 7B, engaging arced tube 58 into guiding channel 95 entails pushing arced tube 58 downward against the rearward surface of latch post 106 so that arced tube 58 contacts the upper surface of curved beak 104 of latch 110. Downward pressure of arced tube 58 against the top of latch beak 104 causes latch 110 to rotate rearward against tortional rotational spring 120 thereby opening latch 110 and allowing arced tube 58 to drop into guiding channel 95. Latch 110 closes over arced tube 58 automatically by force of rotational spring 120. Note that other latching devices are contemplated within the scope of this invention.

Referring to FIGS. 4A, 4B, 6A, and 6B, arced tube 58 is allowed to rotate along an arc of imaginary circle 210 within the guiding channel 95. Rollers 96, low friction surfaces 99, and clearance between arced tube 58 and guiding channel elements facilitate this motion. Lateral rotational motion of arced tube 58 is restricted by left and right protrusions 53 at its ends. These protrusions 53 form rotation limiting stops that encounter the lateral aspects of rear elements 92 of guiding assembly 90 at the extreme of motion of arced tube 58 within guiding channel 95. FIGS. 4A and 4B depict inline and extreme rightward rotation respectively of upper frame assembly 22 in relation to lower frame assembly 24, from a perspective down the pivotal axis of steering 200. Rotation limiting stops may be otherwise constructed within the scope of this invention.

Referring to FIGS. 1A, 4A and 4B, preferred embodiment 20 further comprises upper and lower frame assemblies 22 and 24 in relationship such that the pivotal axis of steering 200 extends down and forward to pass through the lower aspect of front wheel 30. Steering axis 200 extends up and rearward through seat 124 and passes handle 56 at approximate midline, above or below, depending on handle 56 adjustment. In this preferred embodiment axis 200 passes through the anterior aspect of seat 124 such that upper frame assembly 22 exhibits a self centering effect by gravitational forces with or without a child in the seat 124. It is to be understood that other pivotal axis of steering may be employed within the scope of the invention.

Referring to FIGS. 1A and 9, it will be appreciated that the favored three wheeled cart embodiment 20 comprises flexible fabric child seat 124 supported by and between arced seat tubes 32. Seat 124 is also supported in front by mid frame member 40 and in back by upper frame tube 46. Seat is further supported and protected from below by foldable plastic membrane 120 seen in FIG. 6. Restraining harness 114 is attached to seat back 126 and rear side of seat 124, which is attached (not shown) at its lower corners near the junction of upright seat struts 52 and arced tube 58. A footrest wheelguard assembly 132 of the embodiment 20 is positioned to protect the child rider from underlying mechanisms and from road debris that may be thrown up from the front tire 30. Additionally a roll cage like structure is formed by the arched main seat tubes 32 and the upright rear seat struts 52 with the cart in the open operational condition. A further safety feature not shown is a lanyard attached to the junction of seat strut 52 and arced tube 58, to be worn on the wrist of the jogger user to prevent a runaway cart. The user may also slow or stop the moving cart 20 by operation of the standard caliper brake 31 (FIG. 5) by actuating handbrake lever 122, favorably positioned on handle 56 (FIG. 9). The mechanism of lever 122 is provided with a lock enabling the user to lock the brake 31 so that the cart 20 is unable to roll unintentionally with a child rider aboard. Additionally, in the unfortunate event of a rollover a child rider, properly affixed in seat 124, by restraining harness 114 would be protected from an encounter of its head with the ground by the aforementioned roll cage elements.

Referring to FIGS. 4A, 4B and 9, steering of cart embodiment 20 while in use (not shown with rider in seat 124 being pushed by user who is pushing on handle 56 while running, jogging or walking behind cart) is effected by a gentle tortional rotation of handle 56 clockwise or anticlockwise. Clockwise rotation of handle 56 produces rotation of upper frame assembly 22 (including front fork assembly 39) around steering axis 200 in relation to lower frame assembly 24 (see FIG. 4B, full right rotation). This clockwise rotation causes a turning and tilting motion of front wheel 30 to the right thereby steering the cart 20 to the right while in motion. Anticlockwise motion of handle 56 produces a similar rotation, turning, and tilting of the front wheel 30 to the left, thereby steering the cart 20 to the left while in motion. Notably, steering with embodiment 20 is effected without lifting the front wheel 30 off the ground as with fixed front wheel carts. Also notable is that user has full control of direction of travel unlike carts with a castor front wheel. In addition, preferred embodiment 20 tends to self align by gravitational forces, while at rest or in motion, when upper frame 22 is rotated as with steering. When in motion cart 20 will tend to maintain an inline direction of travel until gentle force rotates the handle 56 and will tend to resume inline travel when the force is relaxed. Child seat 124 also tilts with steering rotation of handle 56 and produces an effect such that outward inertial forces of turning are favorably supported by the bottom of seat 124 as though the rider were supported in a swing.

Additionally, rider and user are cushioned from transmission of intermittent forces of cart 20 rolling over uneven surfaces by vertical motion of front wheel 30 and rear wheels 70 allowed by shock members 36 and 74 respectively and the favored configurations of front fork assembly 39 and rear arm assemblies 60 in this embodiment 20. User is also provided with a padded handle 56 in embodiment 20. Additional optional advantageous features of this embodiment 20 include: adjustable reclining seat back 126 for rider comfort and sleep; sun and rain cover 128 for protection of rider from the elements; underseat cargo bag 130; and a beverage holder pouch and a wallet pouch for user located on the rear surface of seat back 126 (not shown).

Referring to FIGS. 1A, 4A, 8, and 9, folding of the preferred cart embodiment 20 is accomplished (without child in seat 124) by user manually releasing latch 110 by pushing down and back on release tab 100 and subsequently lifting upper axial frame tube 46 thereby lifting arced tube 58 from guiding channel 95. Higher lifting of tube 46 elevates mid frame member 40 and attached steering post 86 and steering assembly 80 and attached forward arm connectors 68 thereby lifting front ends of rear arm assemblies 60. Rear wheels 70 swing forward as arm assemblies 60 swing downward, followed by guiding assembly 90 attached to rear support struts 72. A gentle push forward by user on guiding assembly 90 while continuing to lift upper frame tube 46 facilitates and completes forward motion of rear arm assemblies 60 and rear wheels 70 to their fully folded position adjacent to front fork assembly 39 and front wheel 30. All three wheels are now in a forward position as upper frame tube 46 is lowered and upper frame assembly 22 pivots forward at mid frame member 40. As tube 46 is further lowered, steering assembly 80 lowers to the ground and tube 46 is brought forward, over and down to the three wheel assemblies (30, and two 70s). Seat tubes 32 settle outside of wheels 70 and tube 46 encounters front wheel 30. Handle 56 is released by use of knobs 55 and rotated to backside of seat struts 52 as seen in FIG. 8. Handle 56 and struts 52 may be further pushed down thereby folding underseat plastic membrane 120 (seen in FIG. 6, not seen in FIG. 8) to complete the compact folding.

Unfolding and opening cart embodiment 20 is accomplished by user lifting upper frame tube 46 until rear wheel assemblies 70 are hanging down off steering assembly 80. A gentle rearward pull on guiding assembly 90 causes the rear arm assemblies 60 to swing rearward via tension on rear support struts 72. As soon as rear arms 60 are angled outward from steering assembly 80 lowering of tube 46 pushes wheels 70 further out into open position. As upper frame tube 46 is lowered to its final position arced tube 58 is guided to the rear surface of latch post 106. Gentle downward pressure (or force of gravity) results in arced tube 58 engaging in to guiding channel 95 (described in detail above). Latch 110 automatically closes over tube 58 by force of tortional spring 108. Handle 56 is then adjusted to preferred height as previously described by use of adjustment knobs 55.

In addition to a child rider, the upper and lower frame assemblies 22 and 24 of the wheeled cart 20 could support a variety of items and be used in a variety of applications in areas such as medical, mail and parcel, sports, and the like.

In view of the above, it will be seen that the several objects of the invention are achieved and other advantageous results attained.

While certain embodiments of the present invention have been described, it will be understood that various changes could be made in the above constructions without departing from the scope of the invention. It is intended that all matter contained in the above description or shown in the accompanying drawings shall be interpreted as illustrative and not in a limiting sense.

What is claimed is:

1. A steerable wheeled cart, comprising:
an upper frame assembly comprising a pivotable member; and
a lower frame assembly pivotally connected to said upper frame assembly, said lower frame assembly comprising a guiding assembly,
wherein said upper frame assembly is slideably attached to said lower frame assembly at said guiding assembly.

2. The steerable wheeled cart according to claim 1, wherein said upper frame assembly further comprises:
a pair of front parallel tubular members;
a front wheel rotatably connected to said pair of front parallel tubular members;
a connecting tubular member fixedly connected to said pair of front parallel tubular members;
a pair of upright front arced tubular members releasably attached to a front axial tubular member;
an upper rear axial tubular member insertably connected to a connecting member positioned at upper ends of said front arced tubular members, which are also insertably connected to said connecting member;
a pair of upright rear tubular members fixedly connected to upper ends of said front arced tubular members; and
a guiding arced tubular member, each end of said guiding arced tubular member fixedly attached to the lower end of each said upright rear tubular member;
wherein said upper frame assembly prevents a rider from contacting the ground in the event of a roll-over.

3. The steerable wheeled cart according to claim 2, wherein said upper frame assembly further comprises a front shock absorbing assembly having at least one front shock absorbing tubular member.

4. The steerable wheeled cart according to claim 2, wherein said upper frame assembly further comprises a handlebar rotatably connected to said front arced tubular members.

5. The steerable wheeled cart according to claim 1, wherein said lower frame further comprises:
a pair of rear parallel tubular members fixedly attached to and extends in a generally rearward direction from said steerable assembly;
a pair of rear wheels rotatably mounted on said pair of rear parallel tubular members;
a pair of rear shock absorbing tubular members fixedly connected to said pair of rear parallel tubular members;
a guiding assembly fixedly attached to said pair of rear shock absorbing tubular members; and
a pair of parallel supporting tubular members insertably connected to said guiding assembly.

6. The steerable wheeled cart according to claim 5, wherein said guiding assembly comprises:
a guiding channel having a protruding stop positioned in a center area a front end of said guiding assembly;
a plurality of horizontal rollers positioned lateral to said center area;
at least two end pieces positioned at a bottom end of said guiding assembly;
a spring release handle positioned between said two end pieces; and
a releasable and rotatable spring insertably connected to said spring release handle,
wherein said guiding channel of said guiding assembly receives and engages said upper frame assembly, wherein said upper frame assembly is securely held in place by guiding channel, and wherein said upper frame assembly is slidably movable within said guiding channel.

7. The steerable wheeled cart according to claim 6, wherein said spring release handle comprises:
a latch;
a curved neck integrated with said latch; and
a hollow tube having an aperture integrated with said curved neck.

8. The steerable wheeled cart according to claim 1, wherein said upper frame assembly further comprises a footrest and wheelguard assembly.

9. The steerable wheeled cart according to claim 1, wherein said cart further comprises a relined seat wherein a rider may sit in an angled position in said relined seat.

10. The steerable wheeled cart according to claim 1, wherein said cart further comprises a rain and sun cover slidably fitted to said frame assembly.

11. A steerable wheeled cart, comprising:
an upper frame assembly comprising a pivotable member; and
a lower frame assembly pivotally connected to said upper frame assembly, said lower frame assembly comprising a guiding assembly; and
wherein said guiding assembly is fixedly attached to said lower frame, said guiding assembly having a guiding channel and a latch, whereby collapsing motion of said steerable wheeled cart may be achieved by creating a temporary opening of said guiding assembly by applying downward motion on an upper side of said latch, whereby said upper frame assembly may be lifted upwards and away from said guiding channel of said guiding assembly towards a front area of said wheeled cart.

12. The steerable wheeled cart according to claim 11, further comprising:
a front wheel rotatably mounted to said upper frame assembly; and
at least two rear wheels rotatably mounted to said lower frame assembly,
wherein said front wheel and said at least two rear wheels are parallel to one another when said steerable wheeled cart adopts a collapsed position, and wherein said front wheels and said at least two rear wheels are positioned within said frame assembly of said steerable wheeled cart.

13. A collapsible wheeled cart, comprising:
an upper frame assembly;
a lower frame assembly connected to said upper frame assembly;
a guiding assembly fixedly attached to said lower frame assembly, said guiding assembly comprising a guiding channel and a latch;
a front wheel rotatably mounted to said upper frame assembly; and
at least two rear wheels rotatably mounted to said lower frame assembly,
whereby collapsing motion of said collapsible wheeled cart may be achieved by moving said latch to an open position thereby disengaging said guiding assembly, whereby said upper frame assembly may be lifted upwards and away from said guiding channel of said guiding assembly towards a front area of said collapsible wheeled cart.

14. The collapsible wheeled cart according to claim 13, wherein said front wheel and at least two rear wheels are parallel to one another, and wherein said front wheels and said at least two rear wheels are held within said frame assembly when said collapsible wheeled cart adopts a fully collapsible configuration.

15. The collapsible wheeled cart according to claim 13, wherein said upper frame assembly further comprises a pivotable member.

16. The collapsible wheeled cart according to claim 13, wherein said lower frame assembly is pivotally connected to said upper frame assembly of said pivotable member.
